(19) United States
(12) Patent Application Publication
(10) Pub. No.: US 2019/0047782 A1
(43) Pub. Date: Feb. 14, 2019

(54) Multi-Chamber Capsule System For Producing A Beverage

(71) Applicant: BSH HAUSGERAETE GMBH, MUENCHEN (DE)

(72) Inventors: EVGENI REHFUSS, MUENCHEN (DE); PHILIPP KLEINLEIN, MUENCHEN (DE); JAKUB JAN JEDLINSKI, WARSZAWA (PL)

(21) Appl. No.: 16/078,195

(22) PCT Filed: Jan. 20, 2017
(86) PCT No.: PCT/EP2017/051195

§ 371 Date: Aug. 21, 2018

(30) Foreign Application Priority Data
Feb. 22, 2016 (DE) 102016202674.7

(51) Int. Cl. B65D 85/804

(52) U.S. Cl. CPC B65D 85/8043; A47J 31/407

(57) ABSTRACT

A multi-chamber capsule system for producing a beverage has a multi-chamber capsule with an outer shell, which has an outer bottom, an outer sidewall and an outer lid, forming an overall cavity. The capsule also includes at least one inner shell, inside the overall cavity and forming a second chamber to receive a second volume of a second contained substance. A remaining cavity of the multi-chamber capsule is formed by the overall cavity minus the at least one inner shell, as a first chamber to receive a first volume of a first contained substance. The multi-chamber capsule system also includes a device to open the inner shell of the multi-chamber capsule and in order to convey the second contained substance out of the second chamber into the first chamber, to produce a mixture in the multi-chamber capsule which completely contains the first contained substance and the second contained substance.

The invention relates to a multi-chamber capsule system for producing a beverage, in particular for producing an individual portion of a beverage.

A very wide variety of capsule-based beverage systems are used in both professional and consumer applications. On the basis of the capsule content, it is possible to produce hot beverages such as coffee or tea and cold beverages such as carbonated beverages etc. To this end, a capsule usually contains the carrier of a substance to be dissolved in a liquid (in particular in water) in various forms such as for example syrup, powder, etc. The preparation machines prepare the respective beverage in portions as required with the assistance of the capsule contents.

The capsules contain a foodstuff and the storage life of capsules is an important factor for the acceptance of a capsule-based beverage system. One option for extending the storage life of the ingredients of a capsule is to separate the substances (in particular to separate liquid and solid substances), in order for example to prevent chemical reactions. Furthermore, the ingredients of a capsule can also be separated for functional reasons (for example to produce multilayer beverages and/or to control chemical reactions) or for aesthetic reasons.

One example of a multi-chamber capsule is a capsule which has separate chambers for coffee powder and milk powder, as described in EP 2 030 915 A2. On use, the chambers of a multi-chamber capsule are punctured or pierced for example with a hollow needle and flushed with liquid in order to convey the ingredients out of the chambers into the beverage. Alternatively or in addition, a predetermined breaking point can be provided in a capsule which, on production of a beverage, can be broken by means of vapor or liquid pressure in order to open one or more of the capsule chambers.

Further types of capsule and/or capsule systems are described in documents US 2005/0266122 A1, DE 37 22 554 C1, US 2012/0058226 A1, US 2012/0308688 A1, US 2015/0099046 A1, US 2015/0166257 A1, EP 2 030 915 A2, WO 2014/093321 A1 and WO 2014/102701 A1.

The present document addresses the technical object of providing a multi-chamber capsule system which enables improved opening of individual chambers and/or improved mixing of the ingredients from the chambers. The multi-chamber capsule system can to this end comprise means for opening the chambers and/or for mixing the ingredients from the chambers of a multi-chamber capsule. The ingredients of the individual capsules can assume solid, powdered and/or liquid form.

The object is achieved by the subject matter of the independent claim. Advantageous embodiments are in particular defined in the dependent claims, described in the following description or illustrated in the appended drawings.

This document describes a multi-chamber capsule system for producing a beverage. The multi-chamber capsule thereof can accommodate or include in different chambers different ingredients which can be used to produce one or more portions of a beverage. In particular, all the ingredients of the different chambers of a multi-chamber capsule can be mixed within the multi-chamber capsule to form an ingredient mixture in order subsequently to produce the beverage from the ingredient mixture or to provide the ingredient mixture as the beverage.

The multi-chamber capsule comprises an outer shell, which has an outer bottom, an outer side wall and an outer lid which together form an overall cavity of the multi-chamber capsule. In particular, the outer physical form of the multi-chamber capsule can be formed by the outer shell covered with the outer lid. The outer shell can have a round, for example cylindrical and/or conical, shape. In particular, the outer side wall can form the circumferential surface of a hollow cylinder or cone which is covered at one end by the outer bottom and at the other end by the outer lid and so forms the overall cavity in the interior.

The multi-chamber capsule further comprises at least one inner shell which is arranged within the overall cavity of the multi-chamber capsule and forms a second chamber for accommodating a second volume of a second ingredient. The inner shell is here typically formed by an inner bottom and an inner side wall which form a cavity as a second chamber. The inner shell can have a cylindrical and/or conical shape. The multi-chamber capsule can optionally comprise a plurality of such inner shells which are arranged within the overall cavity of the multi-chamber capsule. Different ingredients can be accommodated within each inner shell. In particular, each inner shell can form a cavity as a chamber in which a specific volume of an ingredient can be accommodated. The ingredients can here be liquid, solid and/or powdered.

Subtracting the at least one inner shell (i.e. in particular subtracting all the inner shells of the multi-chamber capsule) from the overall cavity forms a residual cavity of the multi-chamber capsule as the first chamber for accommodating a first volume of a first ingredient. The multi-chamber capsule thus has a plurality of chambers in which in each case a specific volume of (typically different) ingredients can be accommodated.

The multi-chamber capsule is here designed such that, prior to discharge of the ingredients from the multi-chamber capsule (in particular before any ingredient leaves the inner of the multi-chamber capsules), an ingredient mixture can be produced within the multi-chamber capsule, which mixture (substantially completely) comprises at least the first ingredients and the second ingredients. The multi-chamber capsule can thus be designed such that a multi-chamber capsule system can, in the course of the production process, create a cavity within the multi-chamber capsule, in which cavity an ingredient mixture which (substantially completely) comprises at least the first ingredients and the second ingredients can be accommodated. In particular, the ingredient mixture can completely comprise all of the ingredients of the multi-chamber capsule.

The capsule can thus provide a cavity (for example the first chamber) in which the all the ingredients of the capsule can be mixed in order to produce an ingredient mixture which, following the complete mixing operation of the ingredients, can be discharged from the capsule. This complete mixing operation of the ingredients of a multi-chamber capsule prior to discharge of the ingredient mixture enables reliable production of a beverage (of a consistently high quality).

In order to produce an ingredient mixture within the multi-chamber capsule, the volume of the residual cavity of the multi-chamber capsule can preferably be greater than or equal to the sum of the first volume (of the first ingredient) and of the second volume (of the second ingredient). In other words (in particular when a plurality of inner shells are used), the volume of the residual cavity of the multi-chamber capsule (i.e. the volume of the first chamber) can be greater than or equal to the sum of the volumes of all the ingredients present in the capsule. The ingredient mixture can accordingly reliably be produced within the multi-chamber capsule.

As explained above, the inner shell can comprise an inner bottom, an inner side wall and an inner lid. The inner bottom, the inner side wall and/or the inner lid can here be formed at least in part by the outer bottom, by the outer side wall and/or by the outer lid. An inner shell can thus at least in part use a component of the outer shell. This allows a cost-effective multi-chamber capsule to be provided. This moreover enables an efficient and reliable opening and mixing mechanism and thus reliable production of a beverage.

The outer bottom, the outer side wall and/or the outer lid can be formed from a material (for example from a foil, for instance a metal foil) in which an opening can be produced by a needle and/or by pressure in order to provide access to the overall cavity of the multi-chamber capsule and in particular to a chamber. The inner shell, in particular the inner bottom of the inner shell, can furthermore be formed from a material (for example from a foil, for instance a metal foil) in which an opening can be produced by a needle and/or by pressure in order to open the inner shell and thus produce the mixture of the first and second ingredients. This enables the use of efficient and reliable opening and mixing mechanisms and thus reliable production of a beverage.

The at least one inner shell can be arranged in the overall cavity of the multi-chamber capsule in such a manner that, if an opening is present in the inner shell (and if the multi-chamber capsule is suitably arranged in three-dimensional space), the second ingredient is conveyed into the first chamber by gravity. The ingredients can accordingly be mixed particularly efficiently (optionally also without using a flush medium).

The capsule can have an outer shape which enables reliable accommodation of the capsule in a capsule system for producing a beverage and/or which, after use of the capsule, enables reliable ejection of the capsule out of the capsule system. For example, the capsule can have a cuboidal shape or a cylindrical or puck shape.

One aspect of the invention describes a multi-chamber capsule system for producing a beverage. The multi-chamber capsule system can take the form of a home appliance, in particular a household appliance. The multi-chamber capsule system comprises a multi-chamber capsule described in this document. The multi-chamber capsule system moreover comprises means for opening the inner shell of the multi-chamber capsule and for conveying the second ingredient from the second chamber into the first chamber, such that an ingredient mixture is obtained which (largely completely) comprises the first ingredient and the second ingredient. In other words, the multi-chamber capsule system can comprise means (for example one or more needles and/or one or more pressure ducts) for opening the inner shell of the multi-chamber capsule and for creating within the multi-chamber capsule a cavity for accommodating a mixture which completely comprises the first ingredient and the second ingredient.

The multi-chamber capsule can be designed such that the first chamber has a sufficiently large volume to completely accommodate the ingredient mixture (which comprises the entire first volume of the first ingredient and the entire second volume of the second ingredient). Alternatively or in addition, the above-stated means of the multi-chamber capsule system can be configured, on opening of the multi-chamber capsule, to produce a cavity within the multi-chamber capsule which can completely accommodate the ingredient mixture. For example, an inner shell of the multi-chamber capsule can be opened as widely as possible for this purpose. This can, for example, be achieved by a relatively broad needle. The multi-chamber capsule system can thus be configured to produce within the multi-chamber capsule an ingredient mixture which completely comprises all the ingredients of the separate chambers of the multi-chamber capsule. The ingredient mixture can here comprise or be a solution and/or an emulsion of the ingredients from the chambers of the multi-chamber capsule.

The means of the multi-chamber capsule system may for example comprise a first needle which can be introduced from outside into the overall cavity of the multi-chamber capsule (and in particular into an interior of an inner shell) in order to produce an opening in the inner shell (for example in the inner bottom) through which the second ingredient can pass into the first chamber (for example under the action of gravity and/or under the action of a flush medium). Use of a needle enables reliable production of the ingredient mixture.

In order to produce an opening, the first needle can first pierce the material of the outer and/or inner lid in order to pass into the interior of the inner shell. The first needle can then pierce the inner bottom in order to produce the opening through which the second ingredient can pass into the first chamber. On subsequent withdrawal of the first needle (for example after production of the ingredient mixture), the first needle is then passed back past the material of the outer and/or inner lid, whereby the first needle can be automatically cleaned. The production process for a beverage can thus be implemented in cost-effective manner.

The first needle can comprise a first duct (also denoted needle duct) through which a flushing medium (also denoted flush medium) can be flushed from outside into the second chamber in order to convey (for example flush and/or force) the second ingredient through the opening (in the inner bottom of the inner shell) into the first chamber. The first duct can here comprise an elongate cavity which has an outlet on a circumferential surface or at a tip of the first needle, which outlet is at least temporarily located in the second chamber during operation of the multi-chamber capsule system. Using a flushing medium (such as for example water and/or alcohol) enables reliable transfer of the entire second volume of the second ingredient into the first chamber and thus reliable production of the ingredient mixture. Moreover, the first needle duct can be directly cleaned by the flushing medium, such that an efficient production process is enabled.

The first needle can comprise a second needle duct (for example a groove on the side wall of the first needle) through which the second ingredient can pass into the first chamber. Provision of a second needle duct enables reliable transfer of the entire second volume of the second ingredient into the first chamber and thus a high quality ingredient mixture. The second needle duct can here optionally automatically be cleaned by a flushing medium which enables an efficient production process.

The means can comprise a second needle which can be introduced from outside into the overall cavity of the multi-chamber capsule (in particular into the residual cavity, i.e. into the first chamber) in order to produce an opening in the outer shell of the multi-chamber capsule for pressure equalization. The second needle can here optionally comprise a duct (for example a cavity) through which a gaseous medium (for example air or an inert gas from the multi-chamber capsule) can pass outwards out of the overall cavity of the multi-chamber capsule (in particular out of the first chamber). Provision of an opening or a needle duct for pressure equalization enables reliable production of an ingredient mixture.

Alternatively or in addition to the use of a needle, the means can comprise a pressure duct (for example a plunger with one or more pressure ducts) by which an opening can be made in the outer shell and/or in an inner shell. In particular, an opening can be made by a liquid jet, a vapor jet and/or a gas jet. Using a pressure duct is in particular advantageous with regard to cleaning the means for opening the multi-duct capsule.

The multi-chamber capsule system can comprise a control unit which is configured to actuate the means for opening the multi-chamber capsule in order to bring about production of the ingredient mixture in the multi-chamber capsule, in particular in the first chamber. Automatic production of a beverage based on the ingredients of a multi-chamber capsule can be brought about by the control unit.

The multi-chamber capsule system can comprise means for discharging the ingredient mixture from the multi-chamber capsule (in particular from the first chamber) via the outer bottom, via the outer side wall and/or via the outer lid. The entire combined ingredient mixture which comprises a solution and/or emulsion of all the ingredients of the multi-chamber capsule can here be discharged. The ingredient mixture can, for example, be poured from the multi-chamber capsule via a (previously produced) pressure equalization opening in the outer lid. This enables efficient and reliable production of a beverage.

It should be noted that any aspects of the multi-chamber capsule described in this document and/or of the multi-chamber capsule system described in this document can be combined with one another in many and varied ways. In particular, the features of the claims can be combined with one another in many and varied ways.

The invention is described in greater detail below with reference to the appended drawings, in which:

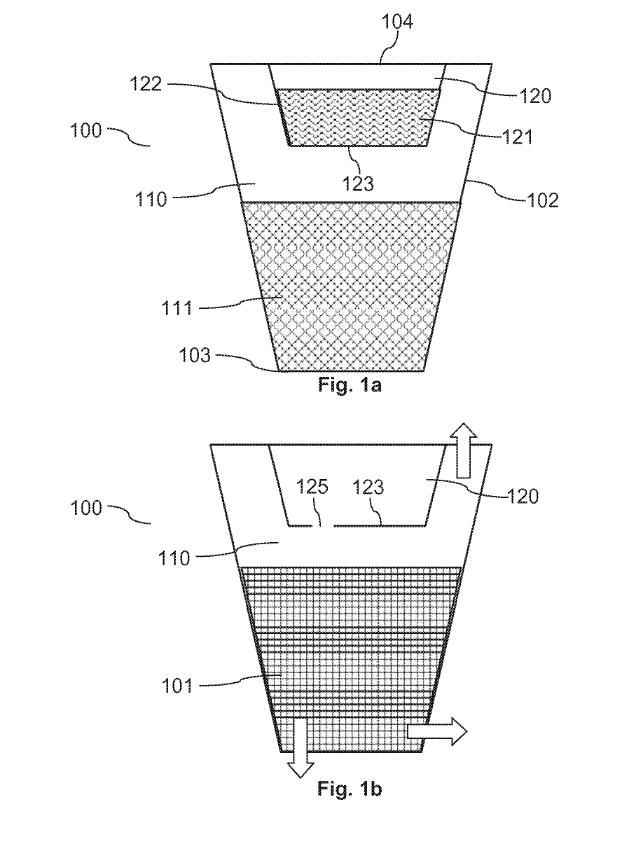

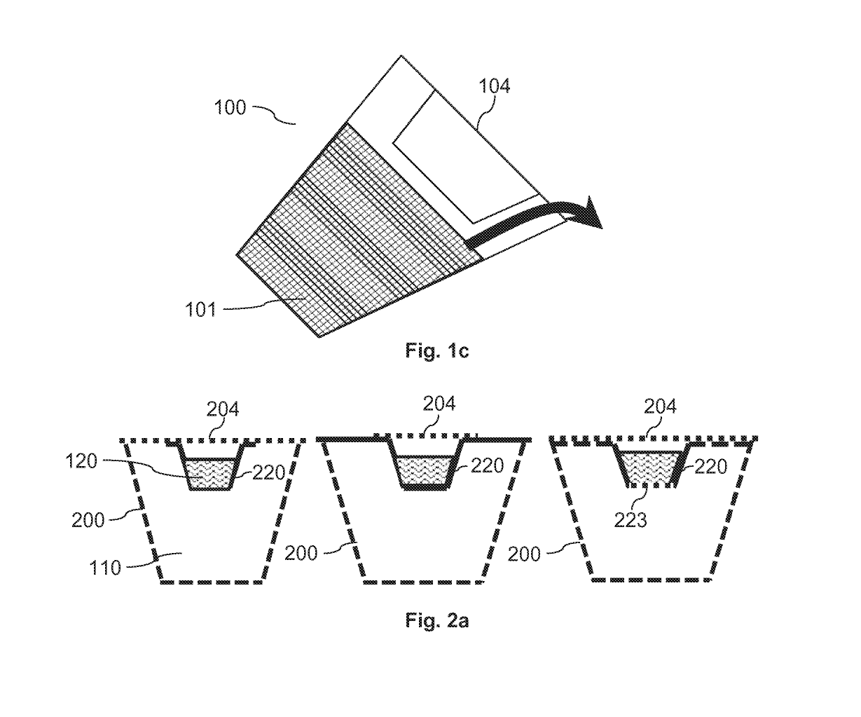

FIG. 1a shows a multi-chamber capsule in the closed state;

FIG. 1b shows a multi-chamber capsule in the open state;

FIG. 1c shows exemplary draining of a multi-chamber capsule;

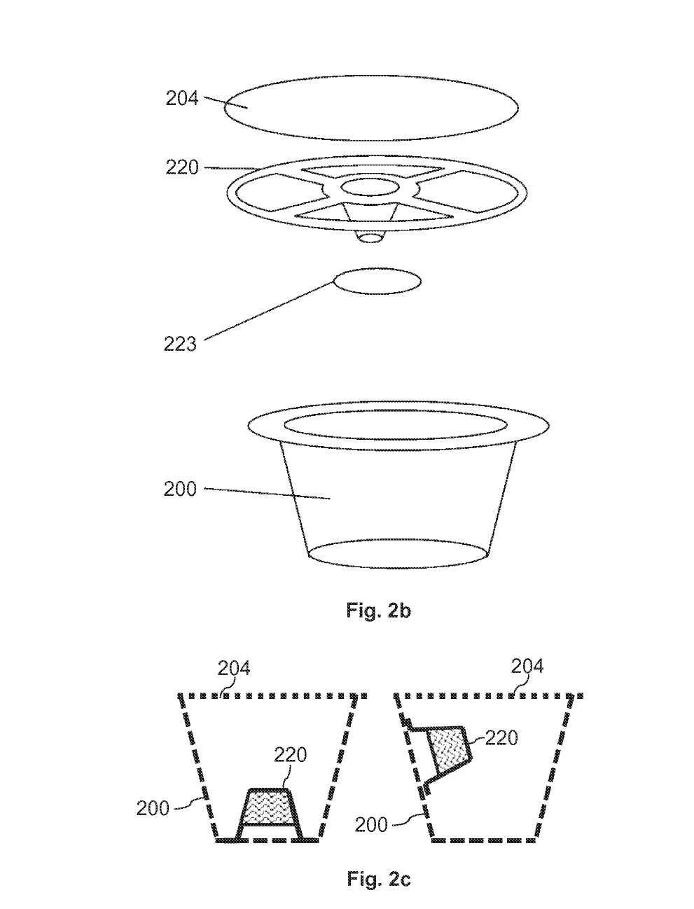

FIG. 2a shows various variants of a multi-chamber capsule;

FIG. 2b shows an exemplary structure of a multi-chamber capsule;

FIG. 2c shows various arrangements of an inner shell in a multi-chamber capsule;

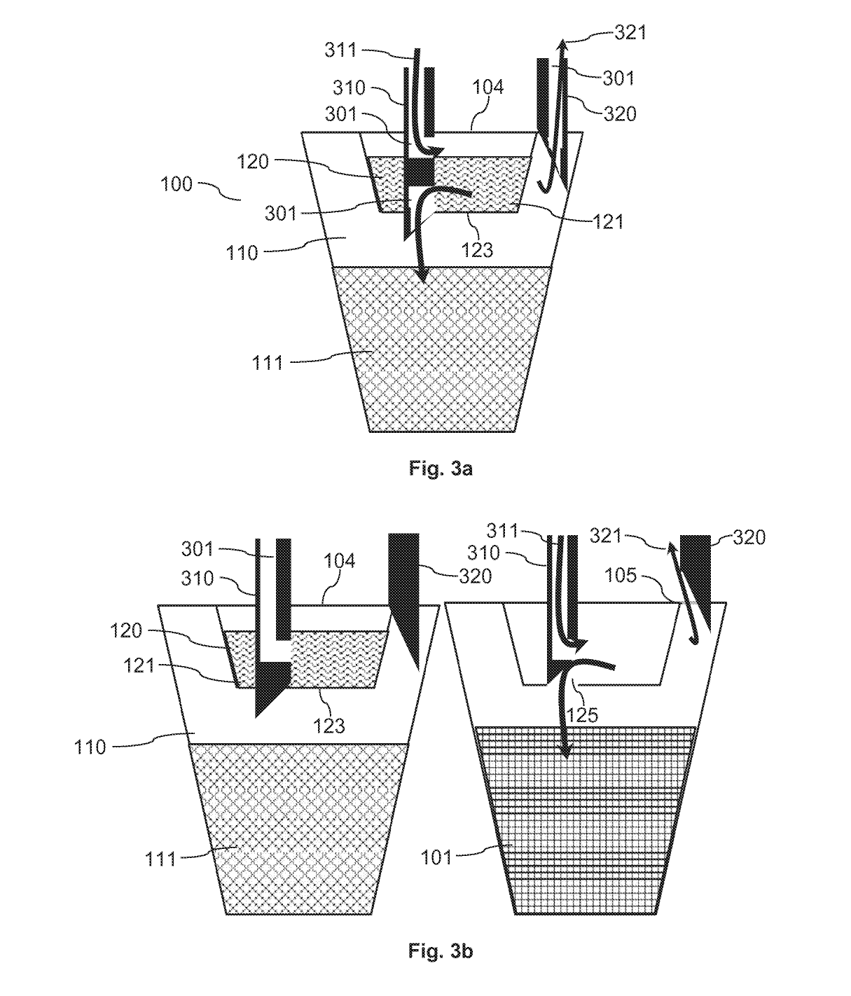

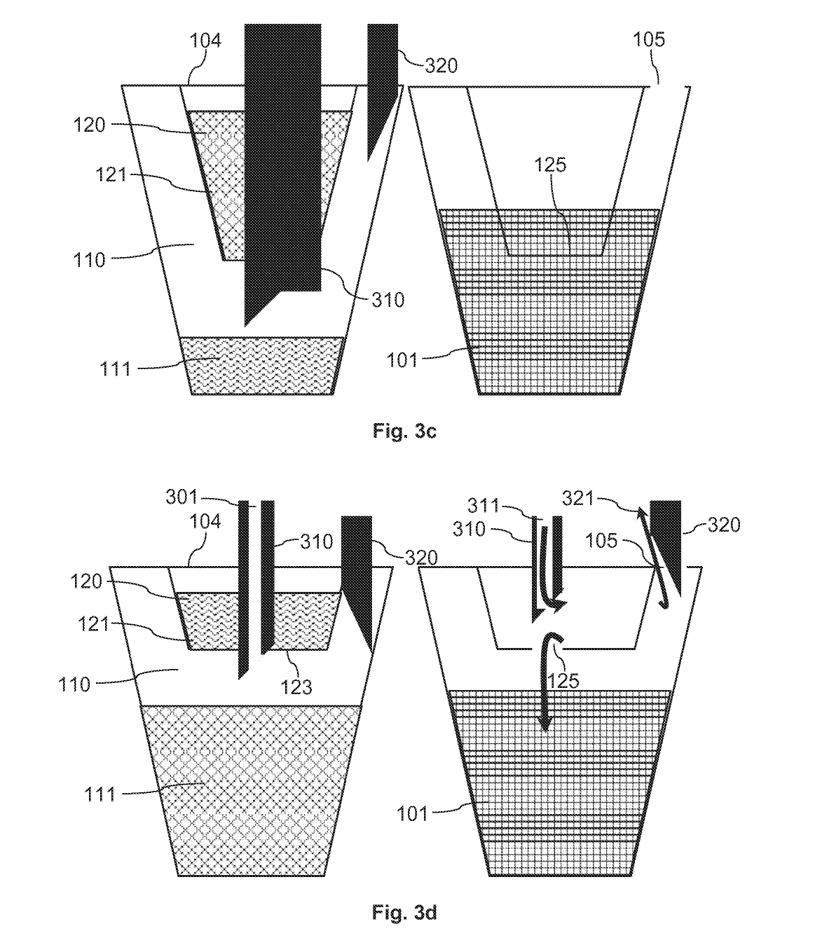

FIGS. 3a to 3d show various variants of needles for opening a multi-chamber capsule;

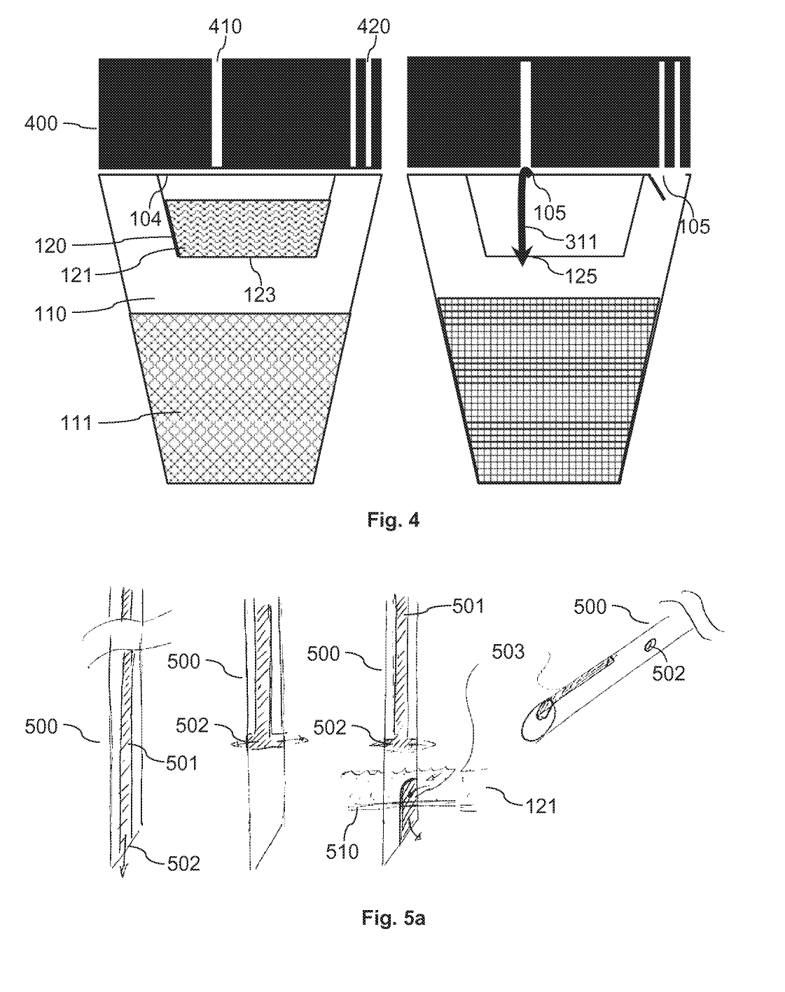

FIG. 4 shows an exemplary plunger with pressure ducts for opening a multi-chamber capsule;

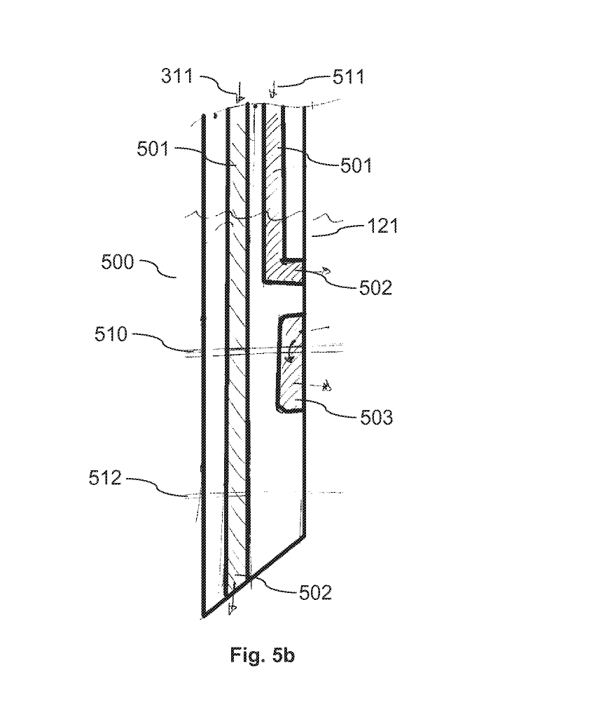

FIGS. 5a and 5b show exemplary needles for a multi-chamber capsule system; and

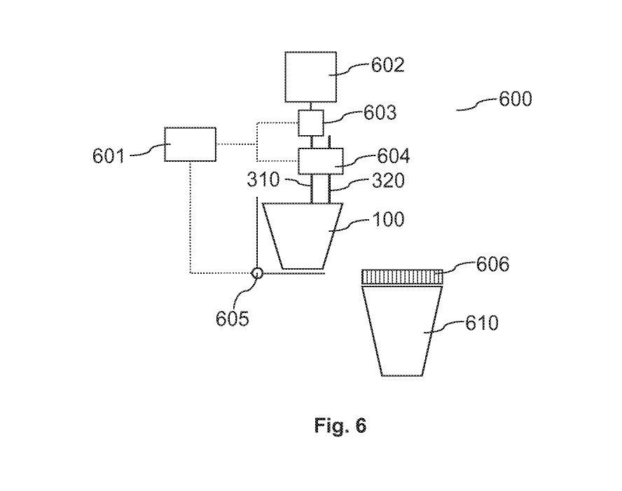

FIG. 6 shows a block diagram of an exemplary multi-chamber capsule system.

As initially explained, the present document relates to a multi-chamber capsule system which enables improved opening of individual chambers and improved mixing of the ingredients of the individual chambers. FIG. 1a shows in this connection an exemplary multi-chamber capsule 100. The capsule 100 comprises two chambers 110, 120, wherein the chambers 110, 120 are formed by separate shells which are nested in one another (similar to a Russian doll). An outer shell is formed by an outer side wall 102 and an outer bottom 103 which enclose an overall cavity of the capsule 100. An inner shell which is formed by an inner side wall 122 and an inner bottom 123 is arranged in the overall cavity. In the example shown, the inner shell and the outer shell are closed by a common lid 104.

The inner shell forms the second chamber 120 for accommodating a second ingredient 121. A plurality of inner shells which form a plurality of separate chambers 120 for accommodating different ingredients can optionally be arranged within the outer shell, i.e. within the overall cavity of the capsule 100. Subtracting the one or more inner shells from the overall cavity forms a residual cavity which forms the first chamber 110 for accommodating a first ingredient 111. The ingredients 111, 121 (which are also denoted substances in this document) can be liquid and/or solid (for example powdered) or comprise liquid and/or solid (for example powdered) components. Each chamber 110, 120 of the capsule 100 can comprise a specific volume of an ingredient. These volumes of different ingredients are substantially completely used for producing a beverage. The chambers 110, 120 can furthermore optionally comprise gases (for example air or inert gas) which are not used to produce the beverage.

The multi-chamber capsule 100 can be constructed such that, in the course of producing a beverage, a cavity can be created within the multi-chamber capsule 100 for accommodating an ingredient mixture 101 which (substantially completely) comprises the first ingredient 111 and the second ingredient 121. In other words, the multi-chamber capsule 100 can be constructed such that an ingredient mixture 101 can be produced within the multi-chamber capsule 100 (for example within the first chamber 110), which mixture comprises all of the ingredients 111, 121 (for example in the form of a solution and/or emulsion) of the capsule 100 which are intended for the beverage. A beverage can accordingly be reliably repeatably produced from multi-chamber capsules 100.

FIG. 1a shows a multi-chamber capsule 100 in the closed state. The multi-chamber capsule system can comprise means (for example one or more needles) for opening one or more chambers 110, 120 of a capsule 100 for mixing the ingredients 111, 121 of the chambers 110, 120 with one another. For example, as shown in FIG. 1b, an opening 125 can be made in the inner bottom 123 of the inner shell, such that the second ingredient 121 can pass (completely) from the second chamber 120 into the first chamber 110 and mix with the first ingredient 111 within the first chamber 110 in order to produce an ingredient mixture 101. The ingredient mixture 101 can then be discharged from the capsule 100 (as shown by the arrows) via one or more further openings (for example in the outer lid 104, in the outer bottom 103 and/or in the outer side wall 102). For example, the capsule 100 can be tilted (as shown in FIG. 1c) in order to pour the ingredient mixture 101 out of the capsule 100 under the action of gravity through an opening in the outer lid 104.

The multi-chamber capsule system can thus for example comprise a needle for puncturing a capsule 100 and means for mixing and/or dissolving the substances 111, 121 (optionally with one or more liquids such as for example water or alcohol or with steam). The multi-chamber capsule system can further comprise means for draining the resultant ingredient mixture 101 and optionally mixing it with a further liquid or transferring it directly into a glass in order to provide a beverage. FIGS. 1a to 1c show a two-chamber capsule by way of example. It is, however, also possible to provide more than two chambers 110, 120 within the overall cavity of a capsule 100. In particular, a plurality of inner shells can be arranged within an outer shell. The inner shells can here be arranged (in part) side by side and/or (in part) nested in one another. By providing an increasing number of shells/chambers, it is possible to increase the complexity of beverages and/or extend the storage life of capsules 100.

As shown in FIG. 1b, the one or more (inner) shells or chambers 120 can be opened in order to mix the substances 111, 121 of a capsule 100 with one another. It is here possible for solely the substances 111, 121 present in chambers 110, 120 to be mixed with one another. Alternatively, one or more further media (for example in liquid and/or gaseous form) can be supplied from outside into the capsule 100 in order to mix the substances 111, 121 of chambers 110, 120 with one another. The mixture 101 produced in the capsule 100 can thus also comprise one or more further media (in particular flush media) in addition to the ingredients 111, 121. The capsule 100 is here preferably designed such that these media can also be accommodated. At least one chamber 120 can be completely drained and, if required, flushed by means of a flush medium in order to produce the mixture 101. The resultant mixture 101 (for example a solution and/or emulsion) can then be supplied to the further beverage preparation process (outside the capsule 100) in various ways.

FIG. 2a shows exemplary structural designs of a capsule 100 with an outer shell 200 and an inner shell 220. As shown on the left-hand side of FIG. 2a, the inner shell 220 and the outer shell 200 are covered by a common lid material 204 (for example by a common foil). As shown in the middle of FIG. 2a, the inner side wall 122 of the inner shell 220 can be shaped such that the inner side wall forms at least part of the outer lid 104 of the outer shell 200. The lid material 204 can in this case optionally cover only the inner shell 220. As shown on the right-hand side of FIG. 2a, the outer side wall 102 of the outer shell 200 can have a profile which extends up to the inner shell 220 and optionally supports the inner shell 220. Foil material 204 can be used for covering the inner shell 220. Foil material 223 can moreover be used to form the inner bottom 123 of the inner shell 220.

The inner shell 220 can thus be arranged directly on the outer lid 104 of the capsule 100. This enables separate production, filling and sealing of the inner shell 220. FIG. 2b shows an exploded drawing of an exemplary capsule 100. In particular, FIG. 2b shows an outer shell 200, a foil material 223 for the inner bottom 123 of the inner shell 220, the inner shell 220 with a structure for supporting the outer lid 104 and a foil material 204 for the outer lid 104 (which also forms the inner lid).

The inner shell 220 can, however, also be arranged at other locations within the outer shell 200, as shown in FIG. 2c. In particular, the inner shell 220 can be arranged on the outer side wall 102 or on the outer bottom 103.

FIGS. 3a to 3d and 4 show various means for opening the chambers 110, 120 and for mixing the ingredients 111, 121 of a capsule 100. In FIGS. 3a to 3d, a first needle 310 is used to produce an opening 125 in the inner bottom 105 of the inner shell 220. The second ingredient 121 can then pass through this opening 125 from the second chamber 120 into the first chamber 110. A second needle 320 can furthermore be used in order to produce an opening 105 in the outer lid 104. This opening 105 can permit pressure equalization in the interior of the capsule 100, in particular if a flush medium 311 (for example water and/or alcohol) is used to flush the second ingredient 121 from the second chamber 120 into the first chamber 111. A gaseous medium 321 (for example air and/or an inert gas) can then flow out from the interior of capsule 100 through the opening 105.

FIG. 3a shows an example in which the first needle 310 has a first duct 301, through which the flush medium 311 can be forced into the second chamber 120, and a second duct 301, through which the second ingredient 121 and optionally the flush medium 311 can be transferred into the first chamber 110. The first duct 301 can be formed by a cavity within the first needle 310 with a lateral outlet on the circumferential surface of the first needle 310. The second duct 301 can be formed by an open groove along the circumferential surface of the first needle 310. The second needle 320 can also comprise a duct 301 (in particular a cavity) through which the gaseous medium 321 can flow out of the capsule 100.

In the example shown in FIG. 3a, the needles 310, 320 can in a first step be introduced into the capsule 100 in the position shown and remain in this position. A flush medium 311 through the first duct 301 of the first needle 310 can then be used to transfer the second ingredient 121 (completely) out of the second chamber 120 into the first chamber 110 and so produce the ingredient mixture 101 in the first chamber 110. The needles 310, 320 can then be retracted. The mixture 101 can then be discharged (for example poured out) from the capsule 100 (for example via the opening 105).

The opening means shown in FIG. 3b comprise two needles 310, 320, wherein the first needle 310 comprises only one first duct 301 for forcing a flush medium 311 into the second chamber 120. In a first step, as shown on the left-hand side of FIG. 3b, the needles 310, 320 are introduced into the capsule 100 in order to produce the openings 125, 105. The needles 310, 320 are then partially retracted (as shown on the right-hand side of FIG. 3b) in order to at least partially uncover the openings 125, 105. A flush medium 311 through the first duct 301 of the first needle 310 can then be used to transfer the second ingredient 121 (completely) out of the second chamber 120 into the first chamber 110 and so produce the ingredient mixture 101. Thereupon, the needles 310, 320 can be completely retracted. The mixture 101 can then be discharged (for example poured out) from the capsule 100 (for example via the opening 105).

FIG. 3c shows an example with needles 310, 320 which have no ducts 301. The first needle 310 can in this case be made relatively large in order to produce a relatively large opening 125 in the inner shell 220 through which the second ingredient 121 (also without using a flush medium 311) can pass completely into the first chamber 110. In the example shown in FIG. 3c, the first needle 310 and optionally the second needle 320 can be introduced into the capsule 100 in order to produce the opening 125 and optionally the opening 105. The first needle 310 and optionally the second needle 320 are then removed from the capsule 100. The mixture 101 can then be discharged (for example poured) from the capsule 100 (for example via the opening 105 or via an opening in the outer lid 104 made by the first needle 310).

The opening/mixing mechanism shown in FIG. 3c can in particular be used when a(n optionally main) liquid component of the mixture 101 is located in the second chamber 120, since a liquid ingredient 121 can typically be reliably and completely transferred into the first chamber 110 by gravity even if a flush medium 311 is not used.

FIG. 3d shows an example in which the first needle 310 has a first duct 301 with which a flush medium 311 can be introduced into the second chamber 120. In this case, the first needle 310 takes the form of a cannula or hollow needle. In a first step, the needles 310, 320 are introduced into the capsule 100 in order to produce the openings 125, 105 (see FIG. 3d, left-hand side) and then partially withdrawn in order to at least partially uncover the openings 125, 105 (see FIG. 3d, right-hand side). A flush medium 311 through the first duct 301 of the first needle 310 can then be used to transfer the second ingredient 121 (completely) out of the second chamber 120 into the first chamber 110 and so produce the ingredient mixture 101. The needles 310, 320 can then be completely retracted. The mixture 101 can then be discharged (for example poured out) from the capsule 100 (for example via the opening 105).

FIG. 4 shows an example in which one or more openings 105, 125 can be produced in the capsule 100 using pressure (for example with a liquid jet of water and/or alcohol). To this end, a plunger 400 is advanced up to and sealed against the outer lid 104 of the capsule 100. The plunger 400 comprises a first pressure duct 410 through which a pressure can be applied to a specific point of the outer lid 104 in order to make the opening 125 in the inner bottom 123. The plunger 400 can furthermore have a second pressure duct 420 through which a pressure can be applied to another (laterally located) point of the outer lid 104 in order to make the opening 105. A jet of liquid or vapor can be “shot” through the pressure ducts 410, 420 in order to make the openings 125, 105. The shape of the opening 125, 105 can here be influenced by the shape of the pressure duct 410, 420. For example, the opening 105 may have a semicircular shape in order to enable reliable “pouring out” of the ingredient mixture 101. Similarly, the shape of a needle 310, 320 can also influence the shape of the opening 105, 125 produced therewith. Once the openings 125, 105 have been produced, the plunger 400 is retracted and the mixture 101 can be discharged (for example poured out) from the capsule 100.

FIGS. 5a and 5b show exemplary needles 500 which can be used in a multi-chamber capsule system. The left-hand side of FIG. 5a shows a needle 500 with a needle duct 501 which takes the form of an elongate cavity in the interior of the needle. Needle 500 is thus a cannula or hollow needle. The needle 500 shown to the right thereof comprises duct outlets 502 on the circumferential surface of the needle 500. The needle 500 shown to the right thereof moreover comprises a second needle duct 503 which takes the form of a groove in order, for example, to guide the second ingredient 121 via an opening in a membrane 510 (for example in the inner bottom 123). The right-hand side of FIG. 5a shows this needle 500 once again from a different perspective.

FIG. 5b shows a needle 500 which has a first cavity duct 501 (with a duct outlet 502 at the tip of the needle 500) and a second cavity duct 501 (with a duct outlet 502 on the circumferential surface of the needle 500). The needle 500 moreover comprises a groove duct 503. Different flush media 311, 511 can be introduced through the cavity ducts 501 into different chambers of a capsule 100 (wherein the chambers are separated from one another by different membranes 510, 512). An ingredient 121 can be transferred from one chamber into another chamber through the groove duct 503. The needle 500 shown in FIG. 5b can for example be used for a capsule 100 with at least three different chambers 110, 120.

FIG. 6 shows a block diagram of an exemplary multi-chamber capsule system 600. The capsule system 600 comprises a control unit 601 which is configured to control the production process for a beverage. A user can introduce a capsule 100 into the system 600 (into a capsule accommodation unit of the system 600 provided for this purpose). The production process can furthermore be started by the user (for example by actuating a button or directly by introducing the capsule 100).

The control unit 601 then ensures that the means 310, 320 for opening the capsule 100 (for example the needles 310, 320) are guided up to the capsule 100 (as shown in connection with FIGS. 3a to 3d and 4). An actuator 604 which for example introduces the needles 310, 320 into the capsule 100 can be actuated for this purpose. A further actuator 603 can furthermore be actuated in order to force a flush medium 311 (for example from a container 602 of the system 600) into the capsule 100 in order to flush a chamber 120 in the capsule 100. A mixture 101 of ingredients 111, 121 from the different chambers 110, 120 can accordingly be produced in the capsule 100. The mixture 101 can then be discharged from the capsule 100. For example, the system 600 can have a tilt mechanism 605 which is configured to tilt the capsule 100, such that the mixture 101 can be poured out of the capsule 101 (for example through the opening 105 in the outer lid 104). In particular, the mixture 101 can be poured out via an output 606 of the system 600 into a cup 610 in which the beverage to be produced is provided to the user. The system 100 can moreover be configured to introduce one or more further liquids for the beverage to be produced into the cup 610.

The described multi-chamber capsules 100 make it possible to accommodate the ingredients 111, 121 for a beverage in separate chambers 110, 120, such that the storage life of beverage capsules 100 can be extended. In particular, liquid ingredients can be separated from solid/powdered ingredients. Alternatively or in addition, separate storage of ingredients 111, 121 can bring about additional functions when the ingredients 111, 121 are combined, for example deliberately brought about chemical reactions such as the liberation of CO₂ and/or the creation of a multilayer beverage.

The means 310, 320, 410, 420 described in this document for opening a capsule 100 enable efficient and reliable opening of a capsule 100. For example, by withdrawing a needle 310, 320 from a resilient closure foil 204 which has previously been precisely pierced by needle 310, 320, the needle 310, 320 can be automatically cleaned on withdrawal by contact with the closure foil 204. By flushing the inner shell 220 with a flush medium 311, the substance 121 present therein can be completely transported out of the inner shell 220. The flush operation also cleans the needle 310, such that contamination between different beverages is avoided. The respectively used opening tool (for example a needle or a pressure duct) can inject further liquids or gases into the capsule 100 via ducts and so ensure optimum mixing of the ingredients 111, 121. Pressure can be equalized within the capsule 100 via openings 105 or notches/ducts 301 on the opening tool (for example on a needle 320).

The present invention is not limited to the indicated exemplary embodiments. In particular, it should be noted that the description and the figures are merely intended to illustrate the principle of the proposed capsule and/or proposed system.

1-15. (canceled)

16. A multi-chamber capsule system for producing a beverage, the multi-chamber capsule system comprising:
a multi-chamber capsule having:
an outer shell with an outer bottom, an outer side wall and an outer lid together forming an overall cavity of the multi-chamber capsule; and
at least one inner shell disposed within said overall cavity of said multi-chamber capsule and forming a second chamber for accommodating a second volume of a second ingredient;
wherein said overall cavity of said of said multi-chamber capsule, with said at least one inner shell subtracted therefrom, defines a residual cavity of said multi-chamber capsule, forming a first chamber for accommodating a first volume of a first ingredient; and
a device configured for opening said inner shell of said multi-chamber capsule and for creating within said multi-chamber capsule a mixture which completely comprises the first ingredient and the second ingredient.

17. The multi-chamber capsule system according to claim 16, wherein said device comprises a first needle to be introduced from outside into said overall cavity of said multi-chamber capsule to produce an opening in said inner shell through which the second ingredient can pass into said first chamber.

18. The multi-chamber capsule system according to claim 17, wherein said first needle is formed with a first duct configured to enable a flushing medium to be flushed from outside into said second chamber in order to convey the second ingredient through said opening into said first chamber.

19. The multi-chamber capsule system according to claim 18, wherein said first duct comprises an elongate cavity which has an outlet on a circumferential surface or at a tip of said first needle, and wherein said outlet is at least temporarily located in said second chamber during an operation of the multi-chamber capsule system.

20. The multi-chamber capsule system according to claim 17, wherein said first needle is formed with a second duct through which the second ingredient can pass into said first chamber.

21. The multi-chamber capsule system according to claim 17, wherein said device comprises a second needle to be introduced from outside into said overall cavity of said multi-chamber capsule in order to produce an opening in said outer shell for pressure equalization.

22. The multi-chamber capsule system according to claim 21, wherein the second needle is formed with a duct configured to enable a gaseous medium to escape out of said overall cavity of said multi-chamber capsule.

23. The multi-chamber capsule system according to claim 16, wherein said device is formed with a pressure duct configured to form an opening in one or both of said outer shell or said inner shell.

24. The multi-chamber capsule system according to claim 16, comprising a control unit configured to actuate said device in order to produce the mixture in the multi-chamber capsule.

25. The multi-chamber capsule system according to claim 16, comprising a discharge device configured to discharge the mixture from said multi-chamber capsule via said outer bottom, via said outer side wall and/or via said outer lid.

26. The multi-chamber capsule system according to claim 16, wherein a volume of said residual cavity of said multi-chamber capsule is greater than or equal to a sum of said first and second volumes.

27. The multi-chamber capsule system according to claim 16, wherein:
said inner shell of said multi-chamber capsule comprises an inner bottom, an inner side wall and an inner lid; and
at least one of said inner bottom, said inner side wall or said inner lid are formed, at least in part, by said outer bottom, said outer side wall or said outer lid, respectively.

28. The multi-chamber capsule system according to claim 16, wherein said outer bottom, said outer side wall and/or said outer lid of said multi-chamber capsule are formed from a material in which an opening can be produced by a needle and/or by pressure in order to provide access to said overall cavity of said multi-chamber capsule.

29. The multi-chamber capsule system according to claim 16, wherein said at least one inner shell of said multi-chamber capsule is arranged in said overall cavity of said multi-chamber capsule such that, if an opening is present in said inner shell, the second ingredient is conveyed into said first chamber by gravity.

30. The multi-chamber capsule system according to claim 16, wherein said inner shell, in particular an inner bottom of said inner shell, is formed of a material in which an opening can be produced by a needle and/or by pressure in order to open said inner shell.

31. The multi-chamber capsule system according to claim 30, wherein said inner bottom of said inner shell is formed of the material in which the opening can be produced by the needle and/or by pressure.
